(19) United States
(12) Patent Application Publication
(10) Pub. No.: US 2005/0252940 A1
(43) Pub. Date: Nov. 17, 2005

(54) Modular holder system

(75) Inventors: Christian Brandstetter, Landshut (DE); Klaus Unterreiner, Geisenhausen (DE)

Correspondence Address: SUGHRUE MION, PLLC, 2100 PENNSYLVANIA AVENUE, N.W., SUITE 800, WASHINGTON, DC, 20037, US

(73) Assignee: LISA DRAXLMAIER GMBH

(21) Appl. No.: 11/113,060

(22) Filed: Apr. 25, 2005

(30) Foreign Application Priority Data
Apr. 27, 2004 (DE) 10 2004 020 552.3

(51) Int. Cl. B60R 7/04

(52) U.S. Cl. 224/543

(57) ABSTRACT

The present invention concerns a modular holder system (1), in particular for use in motor vehicles, with a carrier unit (3) and a number of holder modules (2) for objects. The holder modules (2) are each attached to the carrier unit (3) detachably via a coupling device (5, 6) which has at least one form-fit (6) and one force-fit (5) locking part.

The present invention concerns a modular holder system, in particular for use in motor vehicles, with a carrier unit and a number of holder modules for objects.

Modular holder systems of this type are known (see for example U.S. Pat. No. 6,116,672). The carrier unit is formed by the inner panel of a motor vehicle door which below the arm rest is fitted with a tub-like storage compartment.

The holder modules themselves comprise various trough-like inserts which are lowered from above into the tub-like storage compartment and held therein by gravity.

The trough-like inserts are formed according to the application and can be exchanged to adapt to the required equipment.

The object of the present invention is to refine such a modular holder system such that it can be used in a more versatile and universal manner and be better adapted to modern requirements, in particular in motor vehicle construction.

This object is achieved in that
the holder module is attached to the carrier unit detachably via a coupling device, and
the coupling device has at least one form-fit and one force-fit locking part.

One essential condition for universal usability is an absolutely secure, technically simply constructed, easy to operate coupling device with which the holder module can be attached to the carrier unit.

Whereas holder modules in known modular holder systems are held merely by gravity, according to the invention a coupling device is provided which comprises a form-fit and a force-fit locking part, with which device even relatively heavy and bulky holder modules of widely varying form and shape can be attached absolutely securely to the carrier unit.

This allows a totally new design and consequently opens up totally new possibilities for use and application.

Thus the holder modules can be formed as closed and/or open container units. In the case of a closed container unit they can for example be designed as a briefcase, beauty case, container for hygiene articles or cosmetics, first aid box, waste bin, pistol holder, computer case or similar.

In the case of an open container unit they can be formed as a card holder, net insert, bottle or can holder, or CD box or similar.

Due to the coupling devices, these closed or open container units can with a simple action if necessary be disconnected, taken away or replaced by other container units.

In principle the locking parts can be designed in widely varying ways. It is advantageous if the form-fit locking part of the coupling device is provided as a guide section with slide element guided therein, and the force-fit locking part as a snap lock.

Because of the coupling device according to the invention any “docking direction” can be achieved. Whereas with known modular holder systems it is only possible to insert the trough-like inserts from top to bottom, according to the invention any advantageous direction can be selected. Thus for example for heavy holder modules such as briefcases, suitcases or similar, it can be suitable to “dock” these on the carrier unit substantially only in a horizontal direction.

To facilitate this “docking”, in particular with heavy holder modules, it is advantageous to design the coupling device such that the respective holder module is placed on the carrier unit in a slightly angled position in a first step, inserted in a second step, then in a third step merely tipped up and finally locked in the definitive position. For such a procedure it is advantageous to arrange the guide elements on the carrier unit and the slide element on the holder module concerned.

A particularly advantageous design arises if the form-fit locking part is formed as two guide units which are arranged spaced from each other on the carrier unit.

In particular for carrier units in the form of vehicle doors or vehicle door inner panels, for the respective holder module a recess adapted to its shape is provided. In such a case it is suitable if the two guide units are each arranged in the lower edge area of this recess. It is suitable here that with such a design the sliding elements are arranged on the long sides of the holder module.

In principle the guide units can be designed in any way. Simple operation and advantageous guidance are achieved however if the guide units are formed angled in relation to a horizontal plane, where the insertion area for the slide elements lies above and an end area below the horizontal plane. In this way the holder module, after being placed on the carrier unit, automatically slides into its end position under the effect of gravity and is locked form-fit in this area. The tipping described above and final locking by the force-fit locking part guarantee secure retention even of heavy holder modules.

In principle the guide units can take any course. Particularly simple insertion of the slide elements is ensured if the guide units are designed straight. For secure locking it can however also be suitable to provide a V-shaped course for the guide units.

In principle the snap lock can be formed in any way. Proven designs for such snap locks can be ball or hook engagement devices.

### DESCRIPTION OF FIGURES

The invention is explained in more detail below with reference to FIGS. 1 to 3 given purely as examples.

FIG. 1 shows a perspective view of preferred embodiments of the modular holder system according to the invention.

FIG. 2 shows a perspective view of a holder module.

FIG. 3a shows principle sketches of form-fit locking parts.

FIG. 3b shows a principle sketch of a form-fit locking part.

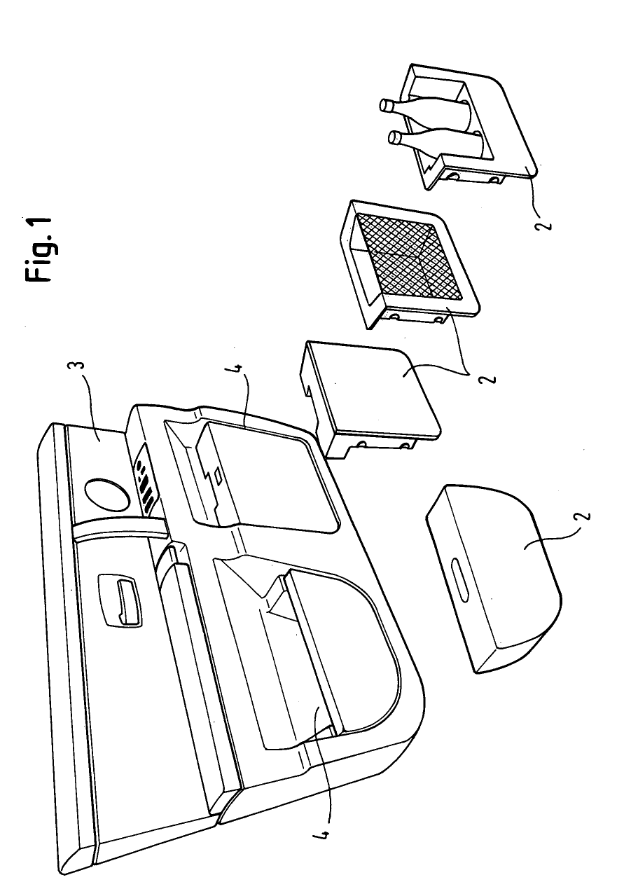

FIG. 1 shows the preferred embodiments of the modular holder system 1 according to the invention. The modular holder system 1 has a carrier unit 3 which is formed for example from the inner panel of a vehicle door. In the carrier unit 3 are provided recesses 4 for receiving holder modules 2. The recesses 4 can have different sizes and shapes which correspond to the size and shape of the respective holder module 2. The holder modules 2 can be formed as closed and/or opened container units. Open container units can for example be formed as holders for drinks containers of any type. With a net insert, the holder module 2 can also be designed flexible in regard to its holding capacity, which for example is advantageous for holding extensive card material. Closed holder modules 2 can also serve a multiplicity of purposes and consequently be adapted to the requirements in each case. In their different embodiments the closed containers can serve e.g. as a first aid box or waste bin.

The holder system according to the invention is not however restricted to this holder module 2, normally inserted in a motor vehicle, but also comprises container units which are specially designed for use both inside and outside the motor vehicle. These holder units can also have carrier devices e.g. handles. For example larger holder modules 2, such as e.g. a briefcase or beauty case, can be positioned in the vehicle and attached easily and securely, and be removed again from the holder system 1 equally simply and quickly. This type of holder module 2 is thus not restricted to exclusive use in the motor vehicle but is also suitable outside the motor vehicle. In general all module units 2 can quickly and easily be connected and disconnected and replaced by other containers or holder modules 2.

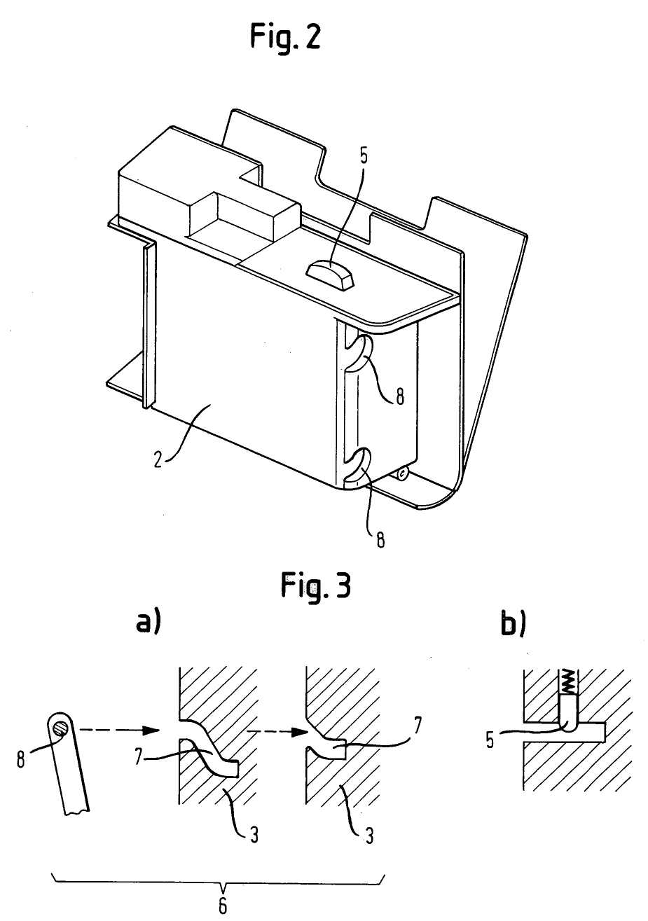

FIG. 2 shows purely as an example a closed holder module 2. According to the invention the holder module 2 is coupled to the carrier unit 3 via at least one form-fit locking part 6 (see FIG. 3a) and one force-fit locking part 5. The combination of form-fit 6 and force-fit 5 locking parts guarantees that even heavy holder modules 2 e.g. briefcases can be attached securely to the carrier unit 3 via the coupling device 5, 6. The container is coupled to the carrier unit 3 first via the form-fit lock 6 and then, as additional security, also via the force-fit lock 5.

The design of the force-fit locking part 5 is not restricted to a particular embodiment but comprises all appropriate force-fit lock types. In a preferred embodiment of the invention, the force-fit locking part 5 is designed as a snap lock, for example, in the form of a ball or hook engagement device (see FIG. 3b).

As shown purely diagrammatically in FIG. 3a, the form-fit locking part 6 comprises at least one guide unit 7 and one slide element 8, preferably however two guide units 7 and slide elements 8. The guide units 7 are preferably arranged on the carrier unit 3 while the slide elements 8 are preferably arranged on the holder module (see FIG. 2). To attach the holder module 2 to the carrier unit 3, as part of the form-fit connection the slide elements 8 are brought into connection with the guide unit 7 and inserted therein.

As is clear from FIG. 3a, the design of the guide unit 7 is not tied to a particular shape but can be adapted to the purpose required (e.g. in relation to the weight differences in holder modules 2). As the guide units in principle can have any course, as well as the outline possible embodiments shown in FIG. 3a for the guide unit 7, also for example straight or V-shaped courses are possible. Due to the many possible designs of the form-fit connection parts 6, the holder modules 2 can be inserted in the guide unit 7 via the slide elements 8 and attached to the carrier element 3 from any direction. A sloping design of the guide units 7 has proved particularly advantageous here, in which the insertion area of the slide element 8 lies above an imaginary horizontal line and the slide element 8 in its end position lies below this imaginary horizontal. In this design the slide element 8, after insertion in the guide unit 7, slides automatically into its end position without further force, merely under the effect of gravity. By means of the final locking via the force-fit locking part 5, an effective and secure connection is achieved between the various holder modules 2 and the carrier unit 3.

1. Modular holder system (1), in particular for use in motor vehicles, with a carrier unit (3) and a number of holder modules (2) for objects, characterized in that
the holder modules (2) are each attached to the carrier unit (3) detachably via a coupling device (5, 6) and
the coupling device (5, 6) has at least one form-fit (6) and one force-fit (5) locking part.

2. Modular holder system according to claim 1, characterized in that the form-fit locking part (6) is formed as a guide unit (7) with slide element (8) guided therein.

3. Modular holder system according to claim 1, characterized in that the force-fit locking part (5) is designed as a snap lock.

4. Modular holder system according to claims 1, characterized in that the holder module (2) is formed as a closed container unit.

5. Modular holder system according to claims 1, characterized in that the holder modules (2) are formed as open container units.

6. Modular holder system according to claim 2, characterized in that the coupling device (5, 6) has two guide units (7) as a form-fit locking part (6) which are arranged spaced apart on the carrier unit (3).

7. Modular holder system according to claim 6, characterized in that the carrier unit (3) has a recess (4) adapted to the holder module (2) and the guide units (7) are arranged in the lower edge area of the recess (4).

8. Modular holder system according to claim 6, characterized in that the slide elements (8) are arranged on the holder modules (2).

9. Modular holder system according to claim 1, characterized in that the guide units (7) are formed sloping in relation to a horizontal plane, where an insertion area for the slide element (8) lies above and an end area below the horizontal plane.

10. Modular holder system according to claim 9, characterized in that the guide units are formed straight.

11. Modular holder system according to claim 9, characterized in that the guide units (7) have a substantially V-shaped course.
